(19) United States
(12) Patent Application Publication
(10) Pub. No.: US 2015/0262465 A1
(43) Pub. Date: Sep. 17, 2015

(54) Child Proximity Alarm Assembly

(71) Applicant: Wilbert Pritchett, Dallas, TX (US)

(72) Inventor: Wilbert Pritchett, Dallas, TX (US)

(21) Appl. No.: 14/211,198

(22) Filed: Mar. 14, 2014

(51) Int. Cl. G08B 21/02

(52) U.S. Cl. CPC G08B 21/0266; G08B 21/0216

(57) ABSTRACT

A child proximity alarm assembly is provided for warning a parent or guardian when a child has been left in a vehicle. The assembly includes a first housing and a second housing. A first proximity alarm system provides a first transmitter coupled to and positioned in the first housing and a first receiver coupled to and positioned in the second housing. The first receiver is operationally coupled to the first transmitter whereby the first proximity alarm system is activated when the second housing is positioned in excess of a pre-determined distance from the first housing. A socket extends into the first housing and a projection is coupled to the second housing. The first proximity alarm system is operationally coupled to the socket and the projection whereby the first proximity alarm system is deactivated by insertion of the projection into the socket.

### BACKGROUND OF THE DISCLOSURE

### Field of the Disclosure

The disclosure relates to child proximity alarm devices and more particularly pertains to a new child proximity alarm device for warning a parent or guardian when a child has been left in a vehicle.

### SUMMARY OF THE DISCLOSURE

An embodiment of the disclosure meets the needs presented above by generally comprising a first housing and a second housing. A first proximity alarm system provides a first transmitter coupled to and positioned in the first housing and a first receiver coupled to and positioned in the second housing. The first receiver is operationally coupled to the first transmitter whereby the first proximity alarm system is activated when the second housing is positioned in excess of a pre-determined distance from the first housing. A socket extends into the first housing and a projection is coupled to the second housing. The first proximity alarm system is operationally coupled to the socket and the projection whereby the first proximity alarm system is deactivated by insertion of the projection into the socket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side view of a child proximity alarm assembly according to an embodiment of the disclosure.

FIG. 2 is a front view of an embodiment of the disclosure.

FIG. 3 is a rear view of an embodiment of the disclosure.

FIG. 4 is a schematic view of an embodiment of the disclosure.

FIG. 5 is a top front side perspective view of an embodiment of the disclosure in use.

### DESCRIPTION OF THE PREFERRED EMBODIMENT

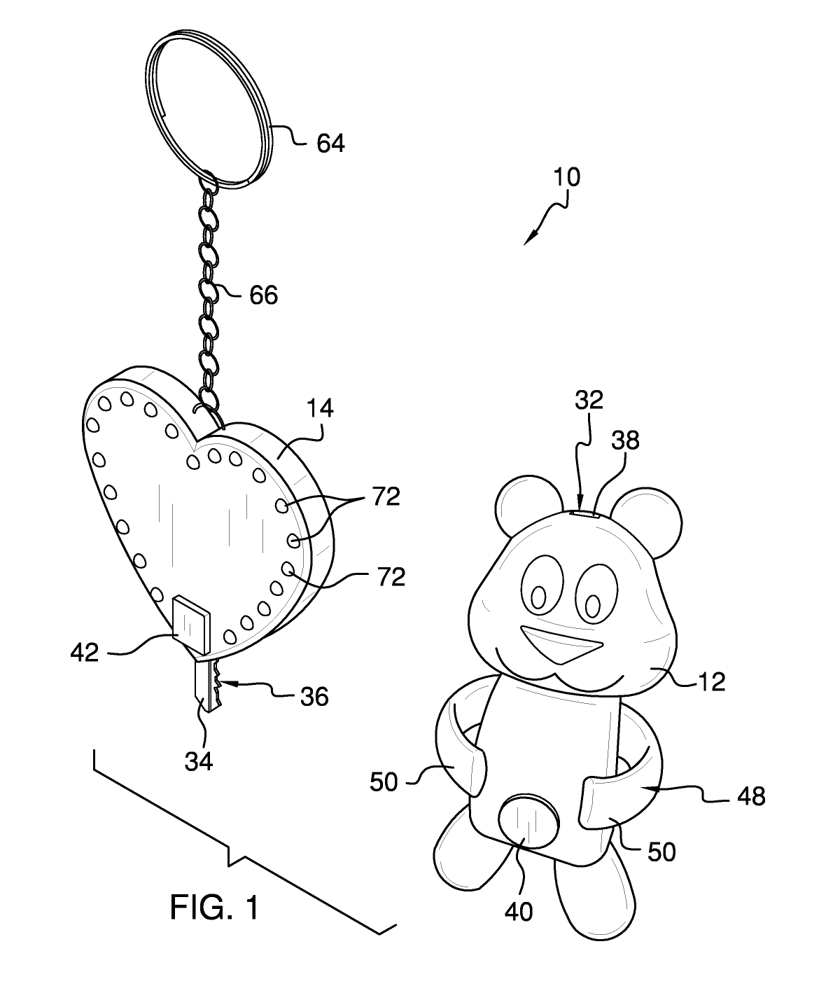

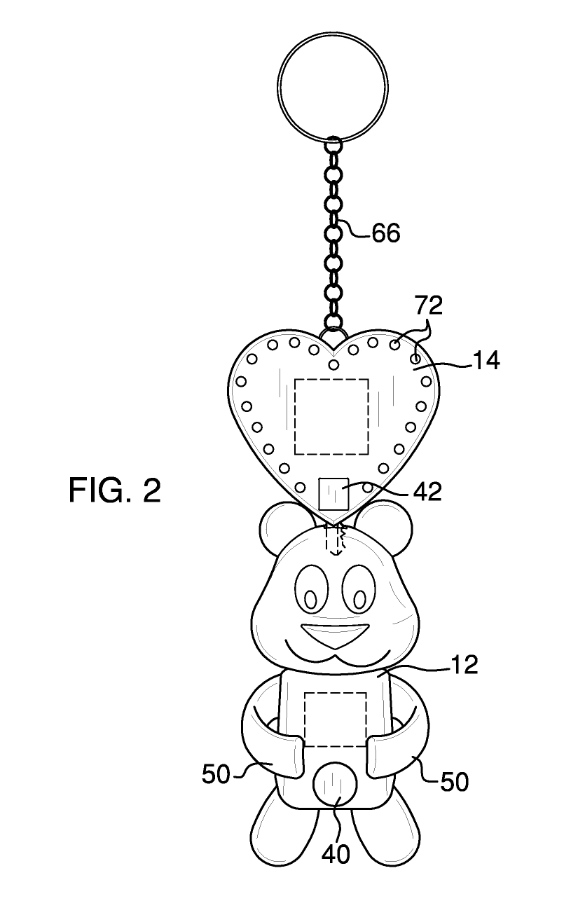

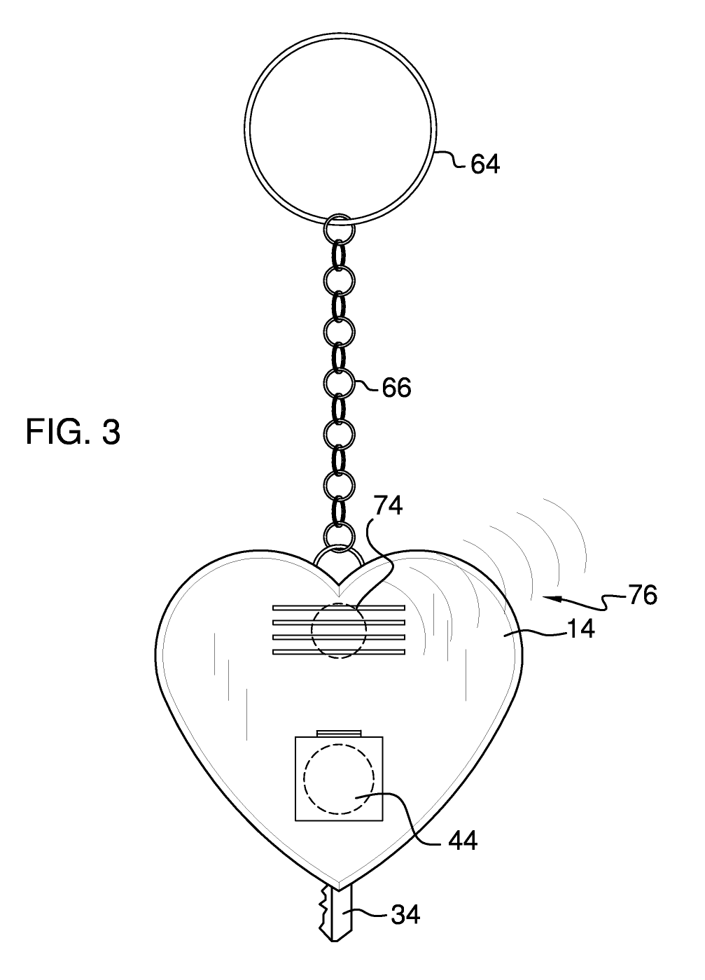

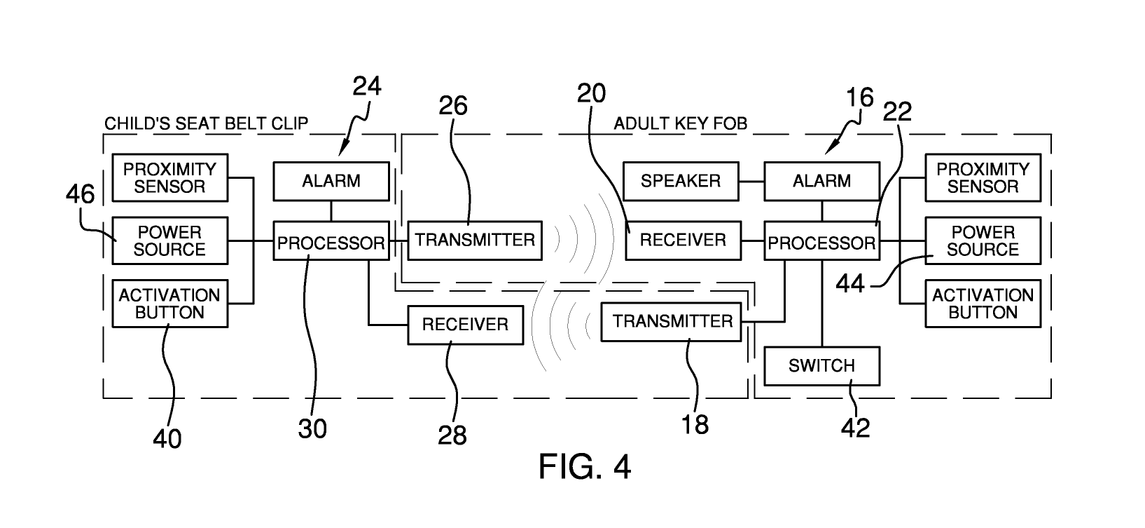

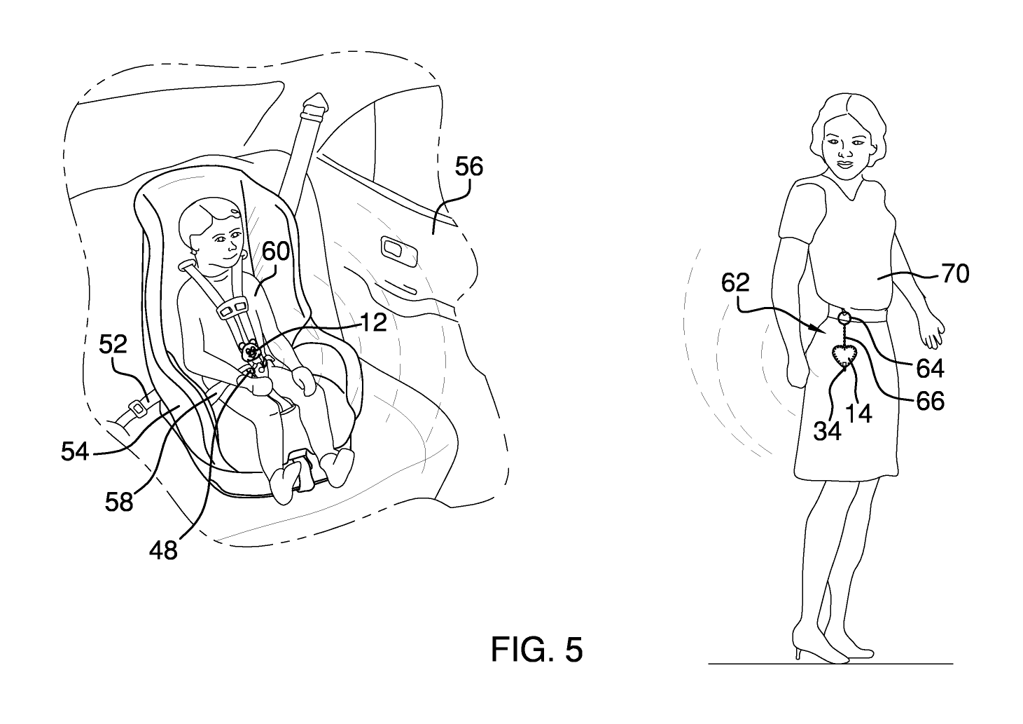

With reference now to the drawings, and in particular to FIGS. 1 through 5 thereof, a new child proximity alarm device embodying the principles and concepts of an embodiment of the disclosure and generally designated by the reference numeral 10 will be described.

As best illustrated in FIGS. 1 through 5, the child proximity alarm assembly 10 generally comprises a first housing 12 and a second housing 14. A first proximity alarm system 16 includes a first transmitter 18 coupled to and positioned in the first housing 12. The first proximity alarm system 16 further includes a first receiver 20 coupled to and positioned in the second housing 14. The first receiver 20 is operationally coupled to the first transmitter 18 whereby the first proximity alarm system 16 is activated to provide an alert when the second housing 14 is positioned in excess of a pre-determined distance from the first housing 12. The first proximity alarm system 16 also has a first processor 22 coupled to and positioned in the first housing 12. The first processor 22 is operationally coupled to the first transmitter 18. A second proximity alarm system 24 includes a second transmitter 26 coupled to and positioned in the second housing 14. The second proximity alarm system 24 includes a second receiver 28 coupled to and positioned in the first housing 12. The second receiver 28 is operationally coupled to the second transmitter 26 whereby the second proximity alarm system 24 is activated to provide a signal when the first housing 12 is positioned in excess of a pre-determined distance from the second housing 14. The second proximity alarm system 24 has a second processor 30 coupled to and positioned in the second housing 14. The second processor 30 is operationally coupled to the second transmitter 26 and the first receiver 20. The first processor 22 is also operationally coupled to the second receiver 28. Thus, the first proximity alarm system 16 and the second proximity alarm system 24 may be interdependent and activated simultaneously.

A socket 32 extends into the first housing 12. A projection 34 is coupled to and may extend from the second housing 14. The projection 34 and socket 32 may be complimentary and unique such as a key 36 and a keyhole 38. The first proximity alarm system 16 and the second proximity alarm system 24 are each operationally coupled to the socket 32 and the projection 34 whereby the first proximity alarm system 16 and the second proximity alarm system 24 are deactivated by insertion of the projection 34 into the socket 32. Thus, the assembly 10 is prevented from accidental deactivation due to handling of the first housing 12 by a child 60.

A first activation button 40 is coupled to the first housing 12. The first activation button 40 is operationally coupled to the first proximity alarm system 16 whereby pressing the first activation button 40 activates the first transmitter 18. The first activation button 40 is further operationally coupled to the second proximity alarm system 24 whereby pressing the first activation button 40 activates the second receiver 28. A second activation button 42 is coupled to the second housing 14. The second activation button 42 is operationally coupled to the first proximity alarm system 16 whereby pressing the second activation button 42 activates the first receiver 20. The second activation button 42 is operationally coupled to the second proximity alarm system 24 whereby pressing the second activation button 42 activates the second transmitter 26. Thus, to activate the assembly 10, both the first activation button 40 and the second activation button 42 must be pressed. A first power source 44, a battery for portability, is electronically coupled to the first processor 22 and all other electronic elements of the assembly 10 found in the first housing 12. Similarly, a second power source 46, also a battery for portability, is electronically coupled to the second processor 30 and all other electronic elements found in the second housing 14.

A clip 48 is coupled to the first housing 12. The clip 48 may be a pair of arcuate arms 50 extending from the first housing 12 whereby the first housing 12 is configured to be coupled to a seat belt 52 securing a child seat 54 to a vehicle 56 or directly to a belt 58 of the child seat 54. The first housing 12 is positioned adjacent to the child 60 and may be shaped like an animal or other shape pleasing to a young child. The clip 48 may be incorporated into the shape to resemble a physical portion of the animal.

A connector 62 is coupled to the second housing 14. The connector 62 may be a chain 66 extending from the second housing 14. Thus, the connector 62 is configured for coupling the second housing 14 to a key fob 64 or the like which may be commonly carried by an adult 70. A plurality of lights 72 may be coupled to the second housing 14 and incorporated into an aesthetic design of the second housing 14. The lights 72 may be light emitting diodes operationally coupled to the first proximity alarm system 16 so that the lights 72 are illuminated when the second housing 14 is positioned in excess of a pre-determined distance from the first housing 12. A speaker 74 is coupled to the second housing 14 and operationally coupled to the first proximity alarm system 16 whereby the speaker 74 transmits an audible signal 76 when the second housing 14 is positioned in excess of a pre-determined distance from the first housing 12. The audible signal 76 may increase in volume over a pre-determined amount of time after the second housing 14 is positioned in excess of the pre-determined distance from the first housing 12 as controlled by the first processor 22. Similar structure may also be incorporated into the second proximity alarm system 24 and the first housing 12.

In use, the first proximity alarm system 16 provides an alarm to the second housing 14. The second proximity alarm system 24 provides an alarm to the first housing 12. The systems 16 and 24 are each activated by pressing the first activation button 40 and the second activation button 42. This can be programmed to require simultaneous pressing or pressing of both within a pre-determined time period. Once activated, such as upon placing the child 60 into the vehicle 56, the assembly 10 monitors proximity of the first housing 12 and the second housing 14. The assembly 10 is deactivated by insertion of the projection 34 into the socket 32. This can be to prevent initiation of a signal permitting separation of the first housing 12 from the second housing 14 or to save battery power when the first housing 12 and second housing 14 remain in close proximity but are not needed to monitor the child 60 being in the vehicle 56. The projection 34 placed in the socket 32 may also be utilized to stop the signal after the first housing 12 has been sufficiently removed from the second housing 14 to initiate the signal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A child proximity alarm assembly comprising:
a first housing;
a second housing;
a first proximity alarm system, said first proximity alarm system including a first transmitter coupled to and positioned in said first housing, said first proximity alarm system including a first receiver being coupled to and positioned in said second housing, said first receiver being operationally coupled to said first transmitter whereby said first proximity alarm system is activated when said second housing is positioned in excess of a pre-determined distance from said first housing;
a socket extending into said first housing; and
a projection coupled to said second housing, said first proximity alarm system being operationally coupled to said socket and said projection whereby said first proximity alarm system is deactivated by insertion of said projection into said socket.

2. The assembly of claim 1, further including a second proximity alarm system, said second proximity alarm system including a second transmitter coupled to and positioned in said second housing, said second proximity alarm system including a second receiver being coupled to and positioned in said first housing, said second receiver being operationally coupled to said second transmitter whereby said second proximity alarm system is activated when said first housing is positioned in excess of a pre-determined distance from said second housing.

3. The assembly of claim 1, further including a first activation button coupled to said first housing, said first activation button being operationally coupled to said first proximity alarm system whereby pressing said first activation button activates said first transmitter.

4. The assembly of claim 1, further including a second activation button coupled to said second housing, said second activation button being operationally coupled to said first proximity alarm system whereby pressing said second activation button activates said first receiver.

5. The assembly of claim 2, further including a first activation button coupled to said first housing, said first activation button being operationally coupled to said second proximity alarm system whereby pressing said first activation button activates said second receiver.

6. The assembly of claim 2, further including a second activation button coupled to said second housing, said second activation button being operationally coupled to said second proximity alarm system whereby pressing said second activation button activates said second transmitter.

7. The assembly of claim 2, further including said first proximity alarm system having a first processor coupled to and positioned in said first housing, said first processor being operationally coupled to said first transmitter and said second receiver.

8. The assembly of claim 2, further including said second proximity alarm system having a second processor coupled to and positioned in said second housing, said second processor being operationally coupled to said second transmitter and said first receiver.

9. The assembly of claim 1, further including a clip coupled to said first housing whereby said first housing is configured to be coupled to a seat belt.

10. The assembly of claim 1, further including a connector coupled to said second housing, said connector being configured for coupling said second housing to a key fob.

11. The assembly of claim 2, further including a plurality of lights coupled to said second housing, said lights being operationally coupled to said first proximity alarm system whereby said lights are illuminated when said second housing is positioned in excess of a pre-determined distance from said first housing.

12. The assembly of claim 2, further including a speaker coupled to said second housing, said speaker being operationally coupled to said first proximity alarm system whereby said speaker transmits an audible signal when said second housing is positioned in excess of a pre-determined distance from said first housing.

13. The assembly of claim 12, wherein said audible signal increases in volume over a pre-determined amount of time after said second housing is positioned in excess of the pre-determined distance from said first housing.

14. A child proximity alarm assembly comprising:
a first housing;
a second housing;
a first proximity alarm system, said first proximity alarm system including a first transmitter coupled to and positioned in said first housing, said first proximity alarm system including a first receiver being coupled to and positioned in said second housing, said first receiver being operationally coupled to said first transmitter whereby said first proximity alarm system is activated when said second housing is positioned in excess of a pre-determined distance from said first housing, said first proximity alarm system having a first processor coupled to and positioned in said first housing, said first processor being operationally coupled to said first transmitter and said second receiver;
a second proximity alarm system, said second proximity alarm system including a second transmitter coupled to and positioned in said second housing, said second proximity alarm system including a second receiver being coupled to and positioned in said first housing, said second receiver being operationally coupled to said second transmitter whereby said second proximity alarm system is activated when said first housing is positioned in excess of a pre-determined distance from said second housing, said second proximity alarm system having a second processor coupled to and positioned in said second housing, said second processor being operationally coupled to said second transmitter and said first receiver;
a socket extending into said first housing;
a projection coupled to said second housing, said first proximity alarm system and said second proximity alarm system each being operationally coupled to said socket and said projection whereby said first proximity alarm system and said second proximity alarm system are deactivated by insertion of said projection into said socket;
a first activation button coupled to said first housing, said first activation button being operationally coupled to said first proximity alarm system whereby pressing said first activation button activates said first transmitter, said first activation button being operationally coupled to said second proximity alarm system whereby pressing said first activation button activates said second receiver;
a second activation button coupled to said second housing, said second activation button being operationally coupled to said first proximity alarm system whereby pressing said second activation button activates said first receiver, said second activation button being operationally coupled to said second proximity alarm system whereby pressing said second activation button activates said second transmitter;
a clip coupled to said first housing, said clip being a pair of arcuate arms extending from said first housing whereby said first housing is configured to be coupled to a seat belt;
a connector coupled to said second housing, said connector having a ring coupled to a chain extending from said second housing whereby said connector is configured for coupling said second housing to a key fob;
a plurality of lights coupled to said second housing, said lights being operationally coupled to said first proximity alarm system whereby said lights are illuminated when said second housing is positioned in excess of a pre-determined distance from said first housing; and
a speaker coupled to said second housing, said speaker being operationally coupled to said first proximity alarm system whereby said speaker transmits an audible signal when said second housing is positioned in excess of a pre-determined distance from said first housing, wherein said audible signal increases in volume over a pre-determined amount of time after said second housing is positioned in excess of the pre-determined distance from said first housing.
